(19) United States
(12) Patent Application Publication
(10) Pub. No.: US 2004/0117470 A1
(43) Pub. Date: Jun. 17, 2004

(54) Temporal service level metrics system and method

(76) Inventor: William A. Rehm, Tulsa, OK (US)

Correspondence Address: Baker Botts L.L.P., Suite 600, 2001 Ross Avenue, Dallas, TX, 75201-2980, US

(21) Appl. No.: 10/320,833

(22) Filed: Dec. 16, 2002

(51) Int. Cl. G06F 15/173

(52) U.S. Cl. 709/223

(57) ABSTRACT

A system and method are provided for employing temporal service level metrics. The system includes a data gathering module operable to collect trouble tickets from service delivery infrastructure components, individual component time records divided into time segments corresponding to specific periods of time, a component calculator module operable to indicate trouble tickets in, the individual component time records, an aggregate time record also divided into time segments corresponding to specific periods of time, and an aggregate calculator module operable to aggregate the component time records into the aggregate time record. The method comprises collecting trouble tickets from a plurality of service delivery infrastructure components, indicating the trouble tickets for each component in an individual component time record divided into time segments corresponding to specific periods of time, and aggregating the component time records into an aggregate time record, also divided into time segments corresponding to the periods of time.

### TECHNICAL FIELD OF THE INVENTION

The present invention relates in general to the field of service level agreements and, in particular, to a temporal service level metrics system and method.

### BACKGROUND OF THE INVENTION

Service Level Agreements (SLA) are contracts negotiated between service providers and clients that define the terms of a service contract, including a price for products or services under specific terms, parameters, and/or guarantees. Whenever the service provided does not comply with the service level guaranteed by the SLA, the customer is typically reimbursed, often at a higher rate than it originally paid for the service.

One difficult aspect of administering SLAs has been the determination of the impact of a service disruption on a SLA contract. Many existing SLA management systems monitor system performance and generate reports, called trouble tickets, whenever the service provided fails to comply with the service level guaranteed in the SLA. These trouble tickets are typically created at the device, software, or system level. However, if the SLA includes a broader definition of service, often a second, nearly duplicate, ticket may be created to ensure accurate reporting. These multiple trouble tickets must then be reconciled using a series of metrics to ensure an accurate accounting of system performance and, therefore, SLA compliance. Often, it has been a matter of subjective interpretation to reconcile trouble ticket and collection agent information with the complex requirements of individual SLAs. Furthermore, this reconciliation has typically been done by spreadsheet, limiting the number of metrics that can be computed cost-effectively.

Although there have been previous attempts to automate trouble ticket reconciliation, such attempts have left much to be desired. The limited number of systems currently available to monitor service disruptions across a service delivery infrastructure are only compatible with certain hardware. Furthermore, these systems employ rules-based reasoning schemes, which must be adapted for each individual system, adding to development and deployment costs. Other systems, that can handle reports from disparate components, are limited to merely displaying the reports and cannot aggregate them.

### SUMMARY OF THE INVENTION

In accordance with the present invention, a system and a method for temporal service level metrics are provided. The system comprises a data gathering module operable to collect trouble tickets from service delivery infrastructure components, individual component time records divided into time segments corresponding to specific periods of time, a component calculator module operable to indicate trouble tickets in the individual component time records, an aggregate time record also divided into time segments corresponding to specific periods of time, and an aggregate calculator module operable to aggregate the component time records into the aggregate time record.

The method comprises collecting trouble tickets from a plurality of service delivery infrastructure components, indicating the trouble tickets for each component in an individual component time record divided into time segments corresponding to specific periods of time, and aggregating the component time records into an aggregate time record, also divided into time segments corresponding to specific periods of time.

Embodiments of the invention provide numerous technical advantages. For example, one technical advantage of particular embodiments of the present invention is the ability to arithmetically aggregate trouble tickets for multiple service delivery infrastructure components, rather than relying on rules-based reasoning schemes in performing these calculations. This allows for greater flexibility and less system-dependence in implementing and performing such calculations.

Another technical advantage of particular embodiments of the present invention is that the temporal service level metrics system makes it possible to aggregate reports from disparate products and move them to a common platform. Reducing the reports to a common platform allows for the easy elimination of redundant trouble tickets. It also helps reconcile trouble tickets for redundant systems in which more than one trouble ticket is required for there to be a service outage.

Yet another technical advantage of particular embodiments of the present invention is that the temporal service level metrics system requires less skill to administer. It also requires less manual effort to analyze and calculate service level metrics, especially in performing roll-up or aggregate calculations given the volume of metrics that occasionally need to be processed. Furthermore, the cost and time frame invested in developing and implementing new benchmarks, metrics calculations, and reporting is greatly reduced, as the system allows the reuse of existing technology, rapid development of new technology, and integration into existing systems without extensive modification.

Other technical advantages will be readily apparent to one skilled in the art from the following figures, descriptions and claims. Moreover, while specific advantages have been enumerated above, various embodiments may include all, some, or none of the enumerated advantages.

### BRIEF DESCRIPTION OF THE DRAWINGS

For a more complete understanding of the invention, and for further features and advantages, reference is now made to the following description, taken in conjunction with the accompanying drawings, in which:

FIG. 1 illustrates a typical service delivery infrastructure that is the subject of a SLA in which trouble tickets are collected from a network of servers;

FIG. 2 illustrates one embodiment of a temporal service level metrics system in which trouble tickets are collected from multiple service delivery infrastructure components;

FIG. 3 illustrates a representation of time records in an embodiment of a system employing temporal service level metrics in which multiple component time records corresponding to multiple service delivery infrastructure components are aggregated into one aggregate time record; and

FIG. 4 illustrates a flowchart depicting one embodiment of a method employing temporal system level metrics.

### DETAILED DESCRIPTION OF THE DRAWINGS

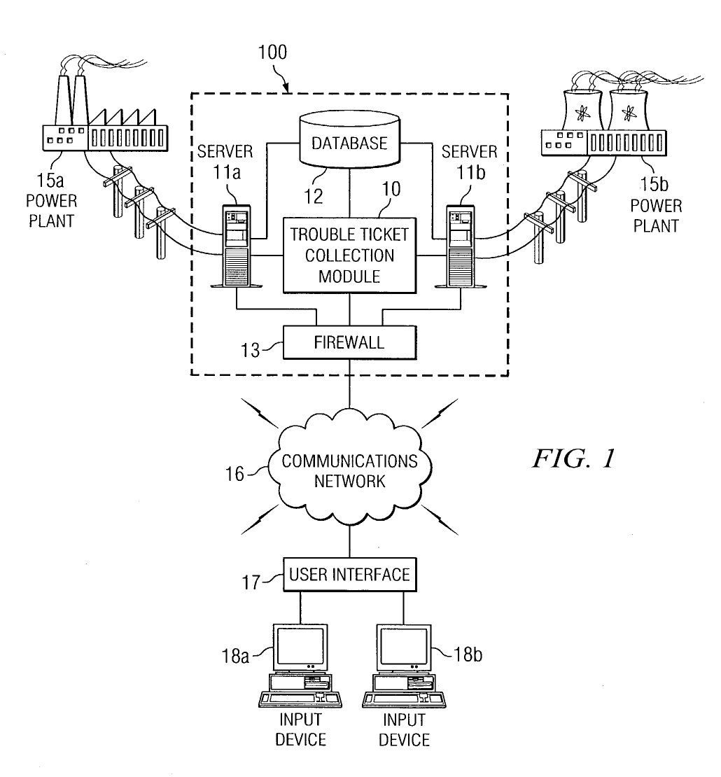

FIG. 1 illustrates a typical service delivery infrastructure 100 that is the subject of a SLA. In this service delivery infrastructure 100, trouble tickets are generated at the hardware level whenever there is a system failure that results in a service outage. These trouble tickets are then reconciled and aggregated to assess the impact of the various service outages on SLA compliance.

Service delivery infrastructure 100 is comprised of trouble ticket collection module 10, server 11a, server 11b, database 12, and firewall 13. In this system, servers 11a and 11b are redundant, meaning service delivery infrastructure 100 can still function with only one of servers 11a or 11b operating. Servers 11a and 11b access information stored on database 12, and provide that information to users at input devices 18a and 18b through communications network 16. To access communications network 16, servers 11a and 11b communicate through firewall 13.

If at any time a component of service delivery infrastructure 100 experiences a system failure, a trouble ticket, or error report, is created and transmitted to trouble ticket collection module 10. The trouble tickets collected by trouble ticket collection module 10 are then reconciled to provide a more accurate account of service delivery infrastructure 100's SLA compliance.

In addition to component failures within service delivery infrastructure 100, events external to service delivery infrastructure 100 can result in a service outage as well. For example, servers 11a and 11b receive electricity from power plants 15a and 15b, respectively. If either power plant 15a or 15b should happen to experience a power outage, server 11a or 11b would experience an outage as well. However, depending on the nature of the external event causing the outage, a trouble ticket may not be generated by a service delivery infrastructure component. To account for such an event, trouble ticket collection module 10 can also receive trouble tickets representing these “virtual assets”, specifically created to account for these external events so that the actual service level provided is accurately represented.

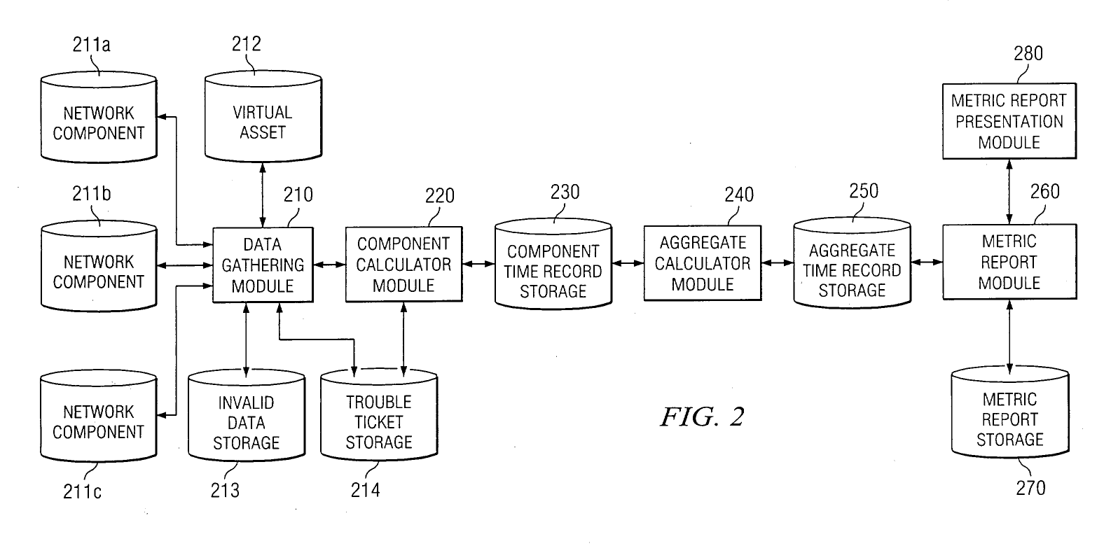

Once trouble tickets have been generated, a method of aggregating and reconciling them is necessary. FIG. 2 illustrates a system employing temporal service level metrics to accomplish the required calculations. In FIG. 2, data gathering module 210 gathers trouble tickets from network components 211a, 211b, and 211c. In addition, trouble tickets are also gathered from virtual asset 212, representing external events, such as power failures, that also result in service outages, as well as trouble tickets manually input by an operator. These manually input trouble tickets may represent other types of service disruptions, even ones that may have already resulted in a trouble ticket generated by a service delivery infrastructure component.

The collection of these trouble tickets can occur in a number of ways. Furthermore, the trouble tickets may come in a variety of formats. For example, in systems using ECPM/Tivoli or Peregrine ServiceCenter, two trouble ticket applications, source data can be collected directly from Oracle Relational Database Management System (RDBMS) storage. On the other hand, in systems using IBM OS/390, Common Interface Message (CIM) data is published via file transfer protocol (FTP) services in a comma separated value (CSV) format.

In addition to gathering the trouble tickets, data gathering module 210 also checks their validity. For example, some systems that generate trouble tickets, such as the Peregrine ServiceCenter application, do not require an event start time entered in a trouble ticket to occur before the event end. Because service disruptions cannot have negative durations, any records with this error are rejected and not considered for further processing. Similarly, trouble tickets with internally inconsistent information would not want to be considering in further processing, either. Therefore, a trouble ticket that indicates a problem in a web hosting categorization, but that has a mainframe processor listed as its asset, is rejected as against pattern. Invalid trouble tickets such as these are stored in invalid data storage 213. These rejected trouble tickets can then be analyzed by operations personnel to correct any misconfiguration that may have contributed to their creation. Trouble tickets that are valid are stored in trouble ticket storage 214 for later processing.

In the event the trouble tickets received are in different formats, as mentioned above, data gathering module 210 is also operable to translate the disparate formats into one common format. This is due to the fact that trouble tickets generated by different software may use different terminology to denote service disruptions. For example, trouble tickets generated by the ECPM/Tivoli application use the value of “OUTAGE/UN” to denote an unscheduled outage. Those generated by the Peregrine ServiceCenter application use “OUTAGE/UN (UNSCHEDULED)”. Although these two are very similar, they must be translated into a common format for the trouble tickets to be reconciled. To accomplish this, data gathering module 210 is operable to translate these trouble tickets into a common format for the remainder of the calculations.

Component calculator module 220 takes the trouble tickets gathered by data gathering module 210 and generates component time records for each service delivery infrastructure component. Each component time record corresponds to a specific period of time, such as one day. The component time record is divided into time segments representing a smaller period of time, such as one minute. Therefore, one day-long component time record could comprise 1440 minute segments (since 24 hours×60 minutes/hour=1440 minutes). For every trouble ticket component calculator module 220 receives, it indicates in the corresponding component time record that a service disruption occurred. This is done by placing a service disruption object in the time segments corresponding to the period of the disruption. These component time records, which are described in even more detail below, are stored in component time record storage 230.

Aggregate calculator module 240 is operable to access the component time records stored in component time record storage 230 and arithmetically aggregate the component time records stored into an aggregate time record. Since all the component time records have a common format, including length and number of time segments, they can easily be arithmetically aggregated, as will be described below. Upon aggregation, the aggregate time record is stored in aggregate time record storage 250.

The aggregate time records in aggregate time record storage 250 are accessed by metric report module 260. From the information stored in the aggregate time records, metric report module 260 is operable to calculate SLA compliance.

Before SLA compliance can be analyzed, however, the aggregate time records must first be reconciled to reflect the realities of the service delivery infrastructure. As mentioned previously, certain components on the service delivery infrastructure may be redundant. Therefore, multiple trouble tickets must be indicated in a time segment of the aggregate record for there to actually be a service disruption in that time period. Additionally, multiple trouble tickets may be generated for a single service outage of one component. For example, two software applications running on the same hardware may both generate trouble tickets in the event the hardware fails. These need to be reconciled to reflect a single outage. All of this is done by metric report module 260, which results in a reconciled aggregate time record indicating a truer representation of actual system performance.

With the reconciled aggregate time record, metric report module 260 computes SLA compliance. In computing SLA compliance, the reconciled aggregate time record is compared with the contracted service schedule. Different service contracts may provide for service for different periods of time. For example, some services are to be provided 24 hours a day, seven days a week, while others are contracted for certain hours of certain days of the week. Additionally, many service contracts provide for an implementation window, a set schedule of periods of time when the service may be unavailable without penalty. Because of these disparate service schedules, the aggregate time record should be checked against the contracted service schedule to accurately calculate SLA compliance.

Metric report module 260 is also operable to generate period-to-date reports, specifying the number of outages for a particular period, such as the month-to-date or year-to-date, for either the entire service delivery infrastructure or just a subset of the service delivery infrastructure.

Having generated these reports, metric report module 260 can then send them to metric report presentation module 280, which displays the result for metric calculations, or metric report storage 270, where they are stored for later review.

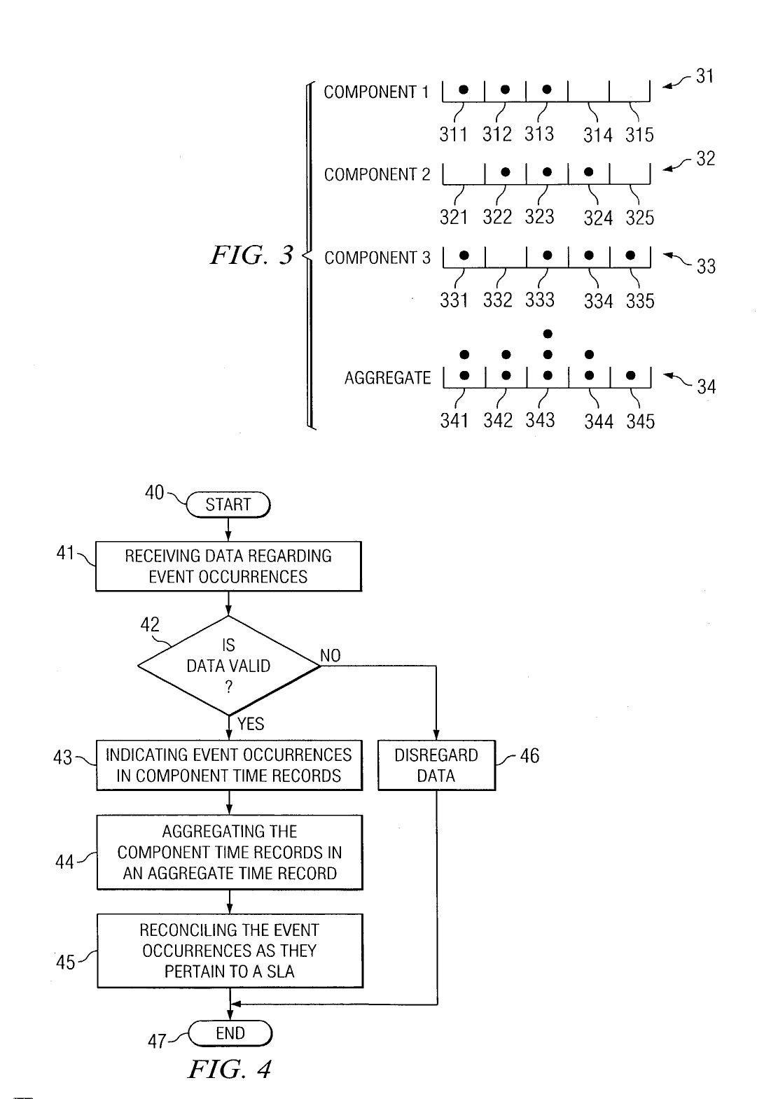

For a better understanding of the component time records and their aggregation into an aggregate time record, FIG. 3 illustrates time records from a temporal service level metrics system. In this system, component time records 31, 32, and 33 are aggregated into one aggregate time record 34. Component time record 31 comprises entries 311, 312, 313, 314, and 315. Each of these entries 311-315 corresponds to a specific period of time. For example, component time record 31 could represent a five-hour block of time, with each entry 311-315 representing a one-hour segment of that time. Likewise, component time record 32 comprises entries 321-325, component time record 33 comprises entries 331-335, and aggregate time record 34 comprises entries 341-345, with the time segments of each record 32-34 corresponding to the same periods of time as the time segments of component time record 31. In this way, entries 321, 331, and 341 all correspond to the same time period as entry 311. Likewise, entries 322, 332, and 342 all correspond to the same time period as entry 312. The remaining entries correspond similarly.

Trouble tickets for the individual components are indicated in the corresponding component time records by recording a service disruption object in the time segment that is the subject of the trouble ticket. In FIG. 3 these service disruption objects are represented by circular marks in the various entries of the component and aggregate time records. Thus, component time record 31 has trouble tickets indicated in entries 311, 312, and 313; component time record 32 has trouble tickets indicated in entries 322, 323, and 324; and component time record 33 has trouble tickets indicated in entries 331, 333, 334, and 335.

The individual component time records 31-33 are arithmetically aggregated into aggregate time record 34. Therefore, the two trouble tickets indicated in entries 311, 321, and 331 of component time records 31-33 are aggregated into entry 341 of aggregate time record 34. Likewise, the trouble tickets indicated in entries 312, 322, and 332 of component time records 31-33 are aggregated into entry 343 of aggregate time record 34. The remaining entries of component time records 31-33 are similarly aggregated into the entries of aggregate time record 34.

In this example, all the entries of aggregate time record 34 have at least one trouble ticket indicated in them. However, assuming component time records 31-33 represent three redundant components, aggregate time record 34 would have to show three trouble tickets (one from each component) for there to be a service outage. In this example, that condition is only met by entry 343 of aggregate time record 34. Although the other entries of aggregate time record 34 reflect at least one trouble ticket, there was no service outage at that time. Of course, if the components weren't redundant, all five entries of aggregate time record 34 would reflect a service outage.

By recording system outages in this simple form, information from service delivery infrastructures of various sizes can easily be aggregated into one system. Unlike currently-available mother-of-all-monitor (MOM) systems, which can only display trouble tickets collected from numerous components, particular embodiments of the temporal service level metrics system also have the ability to perform calculations on those trouble tickets.

Particular embodiments of the present invention also offer the advantage of not being environment-specific. Unlike some SLA compliance systems, these embodiments can collect data from components from a number of different manufacturers. This is especially advantageous for individuals who operate mixed shops, those employing components from multiple vendors, or who outsource portions of their service delivery infrastructures.

Another advantage of particular embodiments of the temporal service level metrics system is that they require less skill to administer and less time to calculate outages than currently available rules-based reasoning systems. Such systems also require less time to implement in new service delivery infrastructures.

Many of these advantages also apply to certain embodiments of the temporal service level metrics method. FIG. 4 illustrates a flowchart depicting one embodiment of this method. This flowchart begins at block 40, which feeds into block 41, where data regarding event occurrences is received from a plurality of service delivery infrastructure components. Examples of event occurrences the data represents include service disruptions.

At block 42, the validity of this data is checked. This validation is performed automatically, and may be implemented, for example, using software or computer media encoded with logic. This validation insures that inaccurate, invalid, or corrupt data is not considered in further steps of the analysis. Examples of such invalid data include trouble tickets that report service disruptions with negative durations or that are internally inconsistent, as has been mentioned previously. In the event the data is invalid, the method proceeds to block 46, where the invalid data is disregarded and not considered for further analysis.

In block 43, data regarding event occurrences reported by service delivery infrastructure components that have passed the validation step are indicated in component time records associated with the individual components. These component time records, include a plurality of component time segments, each corresponding to a period of time, as has already been discussed above in regard to FIG. 3.

These component time records are then aggregated into an aggregate time record in block 44. This aggregate time record comprises a plurality of aggregate time segments corresponding to the same periods of time as the component time segments. Again, use of an aggregate time record and its relation to the component time records has already been discussed above in regard to FIG. 3.

Having been aggregated in the aggregate time record, the event occurrences are then reconciled in block 45 as they pertain to a SLA. At this stage the aggregate time record is reconciled to provide a truer representation of actual system performance. As mentioned previously, this may include the elimination of multiple reports of a single event occurrence. It may also include the elimination of single reports of an event occurrence where the service delivery infrastructure had a redundancy, and thus did not actually experience a service disruption.

Upon this reconciliation, the method then terminates at block 47.

Although embodiments of the invention and their advantages are described in detail, a person skilled in the art could make various alterations, additions, and omissions without departing from the spirit and scope of the present invention as defined by the appended claims.

What is claimed is:

1. A method of recording event occurrences in a service delivery infrastructure comprising:
receiving data from a plurality of service delivery infrastructure components, including first and second service delivery infrastructure components;
the data including information regarding first and second event occurrences received from the first and second service delivery infrastructure components, respectively;
indicating the first event occurrence in a first component time record associated with the first service delivery infrastructure component;
indicating the second event occurrence in a second component time record associated with the second service delivery infrastructure component;
the first and second component time records including first and second pluralities of component time segments, respectively, each component time segment corresponding to a period of time;
aggregating the component time records into an aggregate time record, wherein the aggregate time record comprises a plurality of aggregate time segments corresponding to the periods of time; and
reconciling the first and second event occurrences as they pertain to a service level agreement.

2. The method of claim 1, further comprising validating the first and second event occurrences by disregarding portions of the data that contain errors or internally inconsistent information.

3. The method of claim 1, further comprising disregarding the first event occurrence if the plurality of service delivery infrastructure components includes a third component redundant to the first component, and the third component failed to report a third event occurrence that corresponds to the first event occurrence.

4. The method of claim 1, wherein the first and second service delivery infrastructure components refer to a single service delivery infrastructure component; and
further comprising rejecting the second event occurrence.

5. The method of claim 1, wherein the data further includes information regarding a third event occurrence, the third event occurrence comprising an external event; and further comprising:
indicating the third event occurrence in an external event time record, the external event time record including a plurality of external event time segments corresponding to the periods of time;
aggregating the external event time record into the aggregate time record; and
reconciling the first, second, and third event occurrences as they pertain to a service level agreement.

6. A system for recording event occurrences in a service delivery infrastructure comprising:
a data gathering module operable to collect data from a plurality of service delivery infrastructure components, including first and second service delivery infrastructure components;
the data including information regarding first and second event occurrences received from the first and second service delivery infrastructure components, respectively;
first and second component time records associated with the first and second service delivery infrastructure components, respectively;
the first and second component time records including first and second pluralities of component time segments, respectively, each component time segment corresponding to a period of time;
a component calculator module operable to indicate the first and second event occurrences in the first and second component time records, respectively;
an aggregate time record, wherein the aggregate time record comprises a plurality of aggregate time segments corresponding to the periods of time;
an aggregate calculator module operable to aggregate the first and second component time records into the aggregate time record; and
a metric report module operable to reconcile the first and second event occurrences as they pertain to a service level agreement.

7. The system of claim 6, wherein the data gathering module is further operable to validate the first and second event occurrences by disregarding portions of the data that contain errors or internally inconsistent information.

8. The system of claim 6, wherein the metric report module is further operable to disregard the first event occurrence if the plurality of service delivery infrastructure components includes a third component redundant to the first component, and the third component failed to report a third event occurrence that corresponds to the first event occurrence.

9. The system of claim 6, wherein the first and second service delivery infrastructure components refer to a single service delivery infrastructure component; and
the metric report module is further operable to disregard the second event occurrence.

10. The system of claim 6, and further comprising an external event time record comprising a plurality of external event time segments corresponding to the periods of time; and wherein:
the data further includes information regarding a third event occurrence, the third event occurrence comprising an external event;
the component calculator module is further operable to indicate the external event occurrence in the external event time record;
the aggregate calculator module is further operable to aggregates the first and second component time records into the aggregate time record; and
the metric report module is further operable to reconcile the first, second, and third event occurrences as they pertain to a service level agreement.
